(19) United States
(12) Patent Application Publication
(10) Pub. No.: US 2024/0169375 A1
(43) Pub. Date: May 23, 2024

(54) LINGUISTIC EXTRACTION OF TEMPORAL AND LOCATION INFORMATION FOR A RECOMMENDER SYSTEM

(71) Applicant: PALO ALTO RESEARCH CENTER INCORPORATED, PALO ALTO, CA (US)

(72) Inventors: Ji Fang, Mountain View, CA (US); Victoria M.E. Bellotti, San Francisco, CA (US); Daniel G. Bobrow, Palo Alto, CA (US); Tracy Holloway King, Mountain View, CA (US)

(73) Assignee: PALO ALTO RESEARCH CENTER INCORPORATED, PALO ALTO, CA (US)

(21) Appl. No.: 18/428,805

(22) Filed: Jan. 31, 2024

Related U.S. Application Data
(62) Division of application No. 12/018,511, filed on Jan. 23, 2008.

(51) Int. Cl. G06Q 30/0201; G06F 16/335

(52) U.S. Cl. CPC G06Q 30/0201; G06F 16/335

(57) ABSTRACT

One embodiment of the present invention provides a system that recommends activities. During operation, the system receives a piece of content obtained from text or converted to text from speech. The system then analyzes the received content to identify any activity type, indication of willingness to participate in any type of activities, and at least one piece of temporal information, which can be implicitly and/or explicitly stated in the content, and/or one piece of location information associated with the activity type. The system further recommends one or more activities, venues, and/or services that afford or support activities for a user based on the information extracted from the content.

### RELATED APPLICATIONS

The instant application is related to U.S. patent application Ser. No. 11/857,386 (Attorney Docket No. PARC-20070853-US-NP), entitled “METHOD AND SYSTEM TO PREDICT AND RECOMMEND FUTURE GOAL-ORIENTED ACTIVITY,” filed 18 Sep. 2007; U.S. patent application Ser. No. 11/855,547 (Attorney Docket No. PARC-20070846-US-NP), entitled “RECOMMENDER SYSTEM WITH AD-HOC, DYNAMIC MODEL COMPOSITION,” filed 14 Sep. 2007; U.S. patent application Ser. No. 11/856,913 (Attorney Docket No. PARC-20070746-US-NP), entitled “MIXED-MODEL RECOMMENDER FOR LEISURE ACTIVITIES,” filed 18 Sep. 2007; U.S. patent application Ser. No. 11/857,425 (Attorney Docket No. PARC-20070784-US-NP), entitled “LEARNING A USER'S ACTIVITY PREFERENCES FROM GPS TRACES AND KNOWN NEARBY VENUES,” filed 18 Sep. 2007; and U.S. patent application Ser. No. 11/856,874 (Attorney Docket No. PARC-20070855-US-NP), entitled “USING A CONTENT DATABASE TO INFER CONTEXT INFORMATION FOR ACTIVITIES FROM MESSAGES,” filed 18 Sep. 2007; which are incorporated by reference herein.

### FIELD OF THE INVENTION

The present invention relates to recommender systems. More specifically, the present disclosure relates to an activity recommender system that uses linguistic extraction of implicit or explicit temporal and/or location information.

### RELATED ART

In today's technologically oriented world, a primary source of information is “recommender systems.” A recommender system helps users find information they might not be able to find on their own by generating personalized recommendations in response to some input such as context data, a user model, or a user query. Typically, the user can indicate certain interests, such as a person, place, books, films, music, web content, abstract idea, etc., and the recommender system rates the items within the interest scope and generates a recommendation list. A recommender system can also be used to recommend activities to a user.

For example, a user may receive suggestions from a recommender system on what to do on a weekend evening. The activity recommender system can further provide details of recommended activities, such as movie titles, live performance programs, restaurants, and different types of shops to help the user decide what to do and where to go. However, it remains a challenge to recommend activities that are tailored to a user's short-term needs and general preferences without requiring the user to input specific preference information.

### SUMMARY

One embodiment of the present invention provides a system that recommends activities. During operation, the system receives a piece of content obtained from text or converted to text from speech. The system then analyzes the received content to identify any activity type, indication of willingness to participate in any type of activities, and at least one piece of temporal information, which can be implicitly and/or explicitly stated in the content, and/or one piece of location information associated with the activity type. The system further recommends one or more activities, venues, and/or services that afford or support activities for a user based on the information extracted from the content.

In a variation on this embodiment, identifying the activity type and the temporal and/or location information associated with the activity type involves searching the textual content for one or more predetermined keywords or text patterns.

In a further variation, analyzing the received content involves determining that an activity of the identified activity type has occurred in the past, is occurring at the present time, or will occur at a future time, thereby facilitating determining presence or lack of willingness of the user to participate in the identified type of activities.

In a further variation, when the indication of willingness suggests a lack of willingness to participate in the identified type of activities, or when the activity of the identified activity type has occurred in the recent past or is occurring at the present time, the system demotes the activity type.

In a further variation, when the indication of willingness suggests a willingness to participate in the identified type of activities, or when the activity of the identified activity type will occur at a future time, the system promotes the activity type.

In a variation on this embodiment, the system converts the identified activity type, indication of willingness, and temporal and/or location information to a canonical entry. The system further adds the canonical entry to a repository.

In a further variation, the system causes the canonical entry to expire in the repository based on the temporal information associated with the entry.

### BRIEF DESCRIPTION OF THE FIGURES

FIG. 1 illustrates an exemplary mode of operation of an activity recommender system in accordance with one embodiment of the present invention.

FIG. 2 illustrates an exemplary block diagram for an activity recommender system that extracts implicit or explicit temporal and/or location information in accordance with an embodiment of the present invention.

FIG. 3 presents a flow chart illustrating an exemplary process of extracting implicit or explicit temporal and/or location information from a message to facilitate activity recommendation in accordance with an embodiment of the present invention.

FIG. 4 presents a flow chart illustrating an exemplary process of obtaining a list of activity-related keywords and text patterns in accordance with one embodiment of the present invention.

FIG. 5 illustrates a computer system for extracting implicit or explicit temporal and/or location information to facilitate activity recommendation in accordance with one embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims. In addition, although embodiments of the present invention are described with examples in the English language, application of the present invention is not limited to English, but can be extended to any types of languages, such as eastern Asian languages, including Japanese, Korean, and Chinese.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer readable media now known or later developed.

### Overview

In today's world, one faces many choices on a regular basis, even for small tasks such as where to go for lunch and where to shop. This is partly because there are now more choices available, and partly because information technologies, such as the Internet and wireless technologies, have made information much more accessible than before. Nevertheless, even with recent advances in mobile computing, finding something to do with one's time can still be difficult. There can be a great many choices. Conventional city guides, both online and on paper, are usually difficult to search. On the other hand, location-based search services require the user to input some kind of choice information (such as deciding what to search—shops, restaurants, museums, etc.), which can be frustrating and slow. Furthermore, it is often difficult for an activity recommender system to generate recommendations that are tailored to a user's specific needs, preferences, and habits, without requiring the user to provide these data by hand.

Embodiments of the present invention provide an activity, venue, and/or service recommender system that can extract, from content received or provided by a user, implicit and explicit temporal and location information associated with certain activity types, venues, and/or services to facilitate more personalized activity recommendation. This extracted temporal and/or location information can be used by the recommender system to promote or demote activity types, thereby allowing the recommendations to be more tailored to the user's personal preferences.

In this disclosure, “activity” refers to a set of physical or mental actions or a combination of the two performed over a period of time (typically over at least a few minutes) to accomplish a cognitive goal of which the user is consciously aware. For example, activities can include working, shopping, dining, playing games, playing sports, seeing a movie, and watching a performance. Furthermore, “content” refers to any text a user sends, receives, or inputs to a computing device, or any texts extracted from user speeches. For example, content can include short message service (SMS) messages, instant messages, chat messages, emails, calendar entries, Web postings, etc.

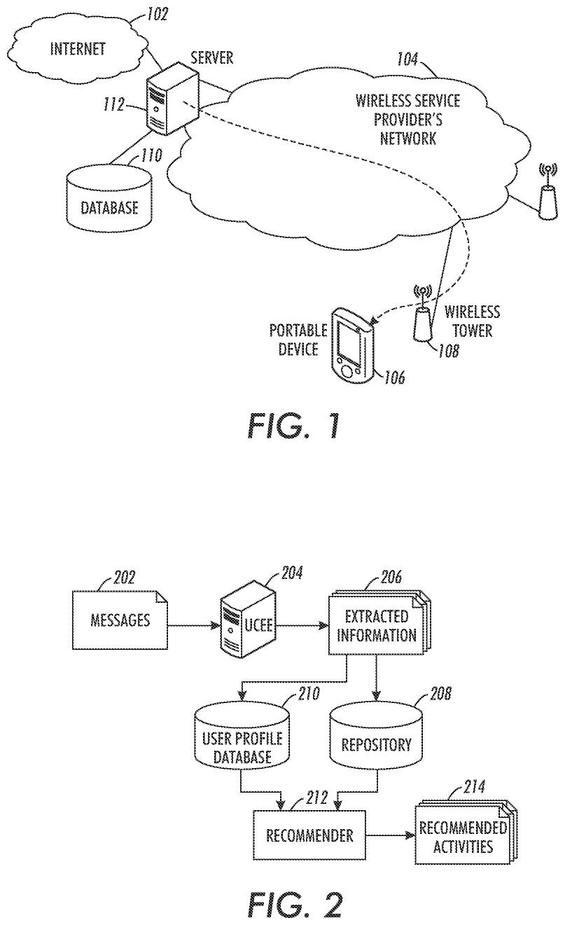

In some embodiments, the present recommender system employs a client-server architecture. FIG. 1 illustrates an exemplary mode of operation of an activity recommender system in accordance with one embodiment of the present invention. In this example, a user's portable device 106 runs the client-side software of the recommender system. Portable device 106 is in communication with a wireless tower 108, which is part of a wireless service provider's network 104. Wireless service provider's network 104 includes a server 112, which is coupled to the Internet 102. During operation, portable device 106 submits queries to server 112. Server 112 runs the server-side software of the recommender system. Server 112 is also in communication with a database 110, which stores the location data, venue/activity data, and optionally the user-profile data for multiple users. In response to the query, server 112 sends a list of recommended activities to portable device 106.

In one embodiment, portable device 106 also provides various forms of text-based mobile applications, such as SMS messaging service, chat service, emails, and calendars. When portable device 106 receives a new piece of content, which may be provided by the user or received from another device, portable device 106 can extract from the content implicit or explicit temporal and/or location information and provide this information to server 112, which then uses this information to promote or demote certain activities. In a further embodiment, portable device 106 may promote or demote activities and produce the recommendation list locally.

### System Architecture and Function

In one embodiment, the recommender system uses activity-related information extracted from content to generate short-term modifications in the recommendation list. These short-term modifications are not permanent, so long as the extracted information has a limited “life span.” That is, the extracted information may be useful to the recommender system only for a limited period of time. However, depending on the type of activity and information extracted, sometimes the extracted information may indicate a long term or more permanent preference of the user. Such information can be stored in a more permanent manner to influence future recommendations.

FIG. 2 illustrates an exemplary block diagram for an activity recommender system that extracts temporal and location information in accordance with an embodiment of the present invention. When one or more messages 202 are received, a user content extraction engine (UCEE) 204 performs analysis to the text of messages 202 and extracts a set of activity-related information 206. Information 206 may include specific terms associated with one or more activity types, temporal information, location information, and a user's preference information associated with an activity or a type of activity. For example, information 206 may indicate that the user is eating at a restaurant, has seen a particular movie the day before, or plans to go shopping in the afternoon. Note that embodiments of the present invention can identify activity types through various means, such as by analyzing text messages, activity models, GPS data, time-of-day, etc.

If extracted information 206 can be used to modify recommendations, extracted information 206 is stored in a repository 208 which is used by a recommender 212 to promote or demote an activity in a recommendation list 214. For example, if messages 202 include an SMS message from a user Bob that says “We ate Italian last night,” the corresponding extracted information 206 can then be used by recommender 212 to demote eating Italian food in the near future, because the temporal expression ‘last night’ in this example implies that the activity of eating Italian food occurred in the recent past, and extracting this piece of implicit temporal information enables the recommender to make more intelligent recommendations. It is possible that the temporal information contained in a message is even more implicit than in the previous example. For example, if message 202 states that “We just ate Italian,” the corresponding extracted information 206 still includes a piece of implicit temporal information that the activity of eating Italian food occurred in the recent past, which is then used by recommender 212 to demote eating Italian food in the near future, even though no overt temporal expression is present in message 202. Note that a user's interest in activities may change over time. Hence, the fact that the user had Italian food last night may decrease his interest in having Italian food again tonight, but make it more likely that he would like to have Italian food in a week or more time. In one embodiment, the system can model the temporal rhythms of the user's interests based on the temporal information to create more accurate user-specific and general profiles.

Note that the entries in repository 208 may be temporary. In one embodiment, the system causes a respective entry in repository 208 to expire based on the nature of the corresponding activity and a set of pre-defined expiration rules. In general, if extracted information 206 indicates that the user is not willing to participate in an activity, recommender 212 can demote this activity. If extracted information 206 indicates that the user is willing to participate in an activity, but the activity is occurring at the present time or has already occurred in the recent past, recommender 212 can also demote this activity. On the other hand, if the extracted information 206 indicates that the user is willing to participate in an activity in the future, recommender 212 can promote the activity.

Furthermore, if extracted information 206 includes information that indicates a long-term or permanent preference of the user, this information can then be stored in a user profile database 210. Recommender 212 can then use user profile database 210 to generate a list of recommended activities 214 that is more tailored to a user's personal preferences. For example, if messages 202 include an SMS message from user Bob that says “No cartoons for me,” extracted information 206 may include an entry that indicates that Bob dislikes cartoon movies in general. This entry can then be stored in user profile database 210 and be used by recommender 212 to demote seeing cartoon movies when recommending activities to user Bob in general. In one embodiment, the entries in user profile database 210 are maintained for a substantially longer period of time compared with the entries in repository 208.

One of the challenges in extracting information from content is the complexity of natural languages. For example, the text “don't want to watch a movie” implies that the user's unwillingness to watch a movie in general is associated with the present time, which indicates that the system probably should not recommend movies at the moment. However, “don't want to watch that movie” implies the user's unwillingness to watch a particular movie at the present time, which indicates that the system probably should not recommend that particular movie at the moment, but may recommend other movies. Another example is “didn't want to watch a movie,” which implies that the user's unwillingness to watch a movie in general is associated with a time in the past, and thus should not influence the system's recommendation at the moment. “Haven't watched a movie” is yet another case, which indicates that the system probably should recommend movies at the moment or in the near future. Therefore, although all of these four examples involve overt negation, they do not lead to the same conclusion because of their different implications. UCEE 204 in FIG. 2 can extract the implicit information implied in these messages, which enables the recommender to make more accurate recommendations. Another challenge is the interpretation of temporal expressions. Most temporal expressions in natural languages are not in a standard, structured format that the system can easily understand (e.g., “tonight,” “next Friday,” “this morning,” etc.). In addition, in most text messages, digits can be very ambiguous. For example, “830” may or may not be a temporal expression.

An additional challenge is the irregularity of the language used in content, particularly in text messages transmitted from mobile devices. Such text messages are likely to contain many abbreviations and grammatical errors compared with conventional writing. Furthermore, the type of abbreviations and grammatical errors are often specific to the language and context. For example, it has been observed that “tmr,” “tml,” and “2morrow” are all commonly used in SMS messages to refer to “tomorrow” in Singapore English. Hence, the quality of information extraction significantly depends on how well the system can regularize the language used in the content.

Because of these challenges, a simple keyword search approach cannot achieve a satisfactory result. In one embodiment, the system uses text patterns in addition to keywords to extract the desired information. In general, the novel key functions for the recommender system are the ability to identify whether a message contains activity related information and which type(s) of activity is discussed in the message, as well as the resolution of temporal or location expressions to a standard time or location format. Referring to FIG. 2, UCEE 204 accomplishes two objectives:
1. Identify whether the user associated with a message is interested in a certain activity or activity type. In other words, identify a user's willingness to participate in the activity.
2. Identify temporal and/or location expressions associated with the activity or activity type, and resolve non-standard temporal and/or location expressions to standard time/location format.

In one embodiment, the system extracts six types of information for all types of activities: activity category (activity type), activity time, tense information, uncertainty of the activity time, activity location, and user's opinion about an activity.

Activity Category

To determine whether a message is related to a certain type of activities, UCEE 204 can use both keyword and pattern filters as well as database-driven searches. For example, to determine whether a message is related to “MOVIE” activities, UCEE 204 can use the keyword “movie” as a filter. In addition to the keyword filter, UCEE 204 can use a list or database of movie titles to guide searching: if a movie title is found following words such as “watch” or “see” in a message, the message is also identified as being related to “MOVIE” activities. Note that constraints on the contexts in which movie titles occur can be important because of the ambiguity of movie titles (i.e., many movie titles include common phrases, such as “The Savages,” “Jaws,” and “Atonement”). Similarly, UCEE 204 can use a database of restaurant names, store names, etc., to determine whether a message is related to the “EAT” or “SHOPPING” activities. Generally, keyword filtering alone is not sufficient for identifying activities. For example, although keywords “buy” and “bought” are often related to “SHOPPING” activities, they are not so when they appear in phrases such as “buy movie tickets,” “buy you dinner,” etc. Hence, text-pattern filters can be used to exclude the latter examples from the “SHOPPING” activities.

It is important for the system to learn the willingness of a user to participate in an activity. In one embodiment, this willingness, or “value” associated with an activity type can be negative, which can be denoted as “NO-EAT,” “NO-MOVIE,” or “NO-SHOPPING.” If the message specifies that the user does not want to engage in certain activity, for example if the messages include the text “no movies for me,” the value of the activity type is set as negative. Accordingly, the recommender system does not recommend movies in the near future. Note that simple negative keywords such as “not” may not be sufficient for this task. For example, “I did not see that movie” and “I have not seen that movie” should not yield a negative activity type value. In one embodiment, the negative activity types are identified through negative pattern cues.

Activity Time, Tense, and Uncertainty

In one embodiment, the system returns a value of activity time for every message that has been identified to correlate to an activity and contain some corresponding temporal information. If a message contains a temporal expression, UCEE 204 can extract the temporal expression through pattern recognition. For instance, UCEE 204 can extract 1-4 digits that are not followed by any digits but are preceded by prepositions such as “at,” “about,” or “around.” UCEE 204 can also convert temporal expressions such as “today,” “Friday” and “weekend” into matching dates in a canonical form such as “YYYY/MM/DD.” In addition, UCEE 204 can standardize hours into a 24-hour format. For example, “7 pm” can be converted into “19:00.” In one embodiment, the standardized time format is “YYYY/MM/DD HH/MM.” However, in many cases, the message may not contain any overt temporal expressions, that is, any temporal information contained in such a message is implicit. In this case, UCEE 204 first checks the tense information. If the message is in the present tense, UCEE 204 assigns the system running time as the value of activity time. For example, if the system receives a message that states “I am watching Finding Nemo,” although no overt temporal expression is found in the message, UCEE 204 returns the time when the message is received as the activity time because the message is in the present tense. Note that in one embodiment the present tense includes both the present simple tense and the present progressive tense.

If the message is not in the present tense, UCEE 204 can provide a default activity time. For example, the message “let's go shopping” is identified as a shopping related message, but there is no overt temporal information available, and the tense is not present. In this case, the system can use a default shopping time of “15:30” as the activity time, as long as the time when the system receives the message is not later than “15:30.” In one embodiment, the system determines the default time for a given activity based on statistics collected from a large poll of users. In further embodiments, for simpler cases such as EAT and MOVIE activities, the default activity time can also be stipulated. For example, UCEE 204 can assign “20:00” as the default movie time, “08:00” as the default breakfast time, “12:00” as the default brunch and lunch time, “19:00” as the default dinner time, and “21:00” as the default pub time.

In one embodiment, the degree to which the system is uncertain of the value of the activity time is recorded by value of UNCERTAINTY. For example, if an activity time is assigned a default value, the corresponding UNCERTAINTY value can be set to 2 hours. If a time expression in a message is preceded by prepositions such as “around” and “about,” the UNCERTAINTY value can be set to 10 minutes. In other cases, the UNCERTAINTY value can be set to 0.

In one embodiment, the recommendation list is set to change immediately after the activity time if UNCERTAINTY is 0.

In general, overt future tense is much less prevalent in text messages compared with the present and past tenses. Based on this observation, UCEE 204 can set future as the default tense. That is, if a message is found to contain linguistic cues of past or present tense, the value of the tense is overwritten accordingly. In one embodiment, the cues for past and present tense are different for different activity types.

As described above, the tense information helps determine the value of the activity time: if the tense is present, the activity time is the system run time. Tense information can also influence the recommendation list. For example, if a message is identified as related to “MOVIE” activities, and its tense is present (as “I'm in a movie”), the recommender system can demote seeing movies as a candidate activity and does not recommend movies in the near future. In addition, tense information can help the system learn user preferences: if a message is identified as related to an activity and its tense is past or present, the information regarding that activity can then be used to learn the user's activity preferences.

Activity Location

To identify an activity location, UCEE 204 searches the message against a list or database of area names and returns any matches. UCEE 204 can also search the message against a list of landmarks and returns the corresponding area in which the landmark is located. For example, for the “EAT” activity, the system can identify whether the activity location is home. If so, the recommender system may not recommend restaurants at the corresponding activity time.

User's Opinion

In one embodiment, UCEE 204 can extract user opinion through keyword and pattern matching.

Activity-Specific Content

In addition to the six common types of information, UCEE 204 can also extract activity specific information. For example, in movie related messages, if a movie title is found, UCEE 204 can return a value of MOVIE-TITLE. This information can be used directly by the recommender system. In eating related messages, UCEE 204 can extract subcategory information of the eating activity, such as “breakfast,” “brunch,” “lunch,” “dinner,” “tea,” “coffee,” or “pub.” This information is extracted mainly through keyword matching. UCEE 2-4 can also search for cuisine types and restaurant names. This information influences the recommendation list and can also be used to learn a user's preferences.

In shopping related messages, UCEE 204 can extract information related to products, store types, and store names. To extract store names, UCEE 204 can search through a list or database of store names and returns the matched value. To extract store types, UCEE 204 can identify hints for each store type. In one embodiment, UCEE 204 uses products as store type hints. For instance, words such as “pants,” “top,” and “dress” are hints for a clothing store. Any or all of products, store types, and store names information can then be used by the recommender to learn a user's preferences.

### Extending Interpretation Over a Series of Messages

It may often be the case that a single message does not contain sufficient information to determine an activity type, location, and/or time. However, a series of messages (e.g., a message thread) is more likely to contain more information when considered together and in their proper sequence. For example, the following series of messages provide more information than any single message in the series, where the useful terms are capitalized:
User A: What do you want to do TONIGHT?
User B: Dunno how about DINNER?
User A: OK what?
User B: CHINESE
User A: No . . . I HATE CHINESE
User B: What about SUSHI?
User A: There's loads of places in ROPPONGI
User B: OK. Meet you at the STATION AT 8?
User A: OK.

UCEE 204 can build up a more accurate model of the evening's plans over the series of messages. In one embodiment, UCEE 204 may revise the model as a sequence of messages unfolds. In the example above, UCEE 204 can negate a higher probability of interest in Chinese restaurants for dinner and substitute a high probability of interest in sushi restaurants instead. The recommender system may react by modifying its recommendations over time or use a threshold of certainty about the user's interests before allowing its model to influence its recommendations.

In the example above, the temporal expression “TONIGHT” in the first message suggests that the “8” in the second last message is more likely to mean “8 pm” than “8 am.” However, even if overt temporal expression such as “TONIGHT” does not exist, UCEE 204 can still make the same inference by extracting implicit temporal information contained in other messages in the thread. For example,
User A: What do you want to do?
User B: Dunno how about DINNER?
User A: OK when?
User B: What about 8?
User A: OK.
   In this case, the implicit temporal information implied by “DINNER” allows the system to infer “8” to be “8 pm” (“20:00”).

### Generating Text Patterns

The accuracy of information extraction largely depends on the quality of text patterns and keywords used to search the text content. In one embodiment, the system uses a corpus that represents the writing style of the target users as the source for text patterns and keywords. “Corpus” as used herein refers to a collection of documents, such as SMS messages, emails, calendar entries, blog posts, etc.

In one embodiment, documents in the corpus are divided into two sets: one development set and one test set. The development set is used to develop strategies and methods for extracting the desired information. The test set is used for testing the strategies and methods developed based on the development set. In one embodiment, to evaluate the strategies and methods, the test set is manually marked with information that is to be extracted. The marked test set is then used as a gold standard test set against which the results produced by the search patterns are compared.

Generally, the language used in text messages transmitted from mobile devices tends to be very different from regular writing. Therefore, resources such as dictionaries of common abbreviations in SMS messages can be very useful. These dictionaries are typically available online. In addition, databases of products, movie titles, locations, attractions, museums, theaters, store and restaurant names, and other venue names can also be useful.

In one embodiment, the patterns are recognized and selected manually from the training set. Although this selection process involves human learning and decision-making, manual pattern selection can ensure a high quality of recognition and accommodate irregular language usage. Furthermore, manual pattern selection can also be used in different languages.

In one embodiment, a message-based test set is marked up with gold standard markup in two ways:
1. Activity category (EAT, SEE, DO, NONE). A given message can be classified with more than one activity category.
2. Time/date expressions in canonical forms.

The gold standard labeling with activity category allows determination of how many of the messages contain information that can be used by the recommender system. This labeling can also facilitate testing of the activity detection method to see how many messages can be correctly categorized. This labeling is important in determining how useful extracting content from messages could be for the system, and how well the content extraction engine performs.

The gold standard markup of time and date expressions involves extracting time and date expressions from the messages in the test set. The content extraction component is then tested against these markups to see how well the extraction engine performs when extracting and canonicalizing time/date information.

### System Operation

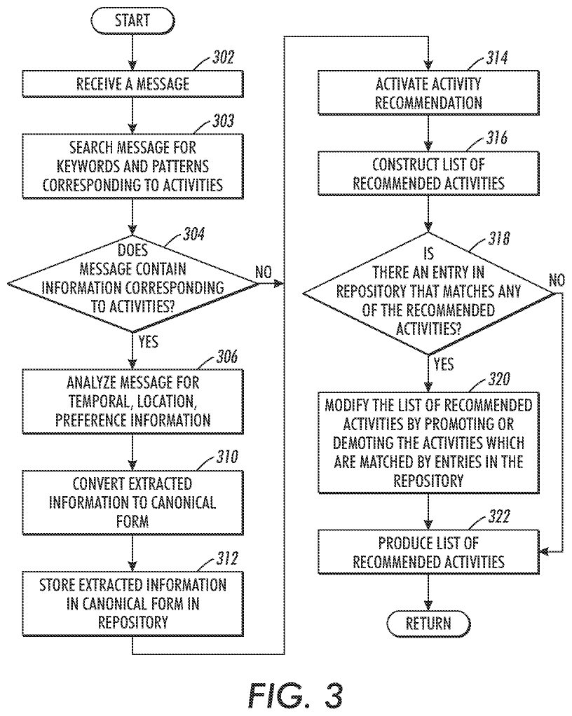

FIG. 3 presents a flow chart illustrating an exemplary process of extracting implicit or explicit temporal and/or location information from a message to facilitate activity recommendation in accordance with an embodiment of the present invention. During operation, the system receives a message (operation 302). Note that this message may be received at a user's mobile device from another device, or typed into the mobile device by the user. The system then searches the message for keywords and patterns corresponding to activities (operation 303). Next, the system determines whether the message contains information corresponding to activities based on the search result (operation 304). This information may indicate one or more activities or activity types, as well as the user's willingness to participate in the activity.

If the message contains activity related information, the system analyzes the message for implicit and explicit temporal, location, and preference information (operation 306). Note that this process may involve further keyword and pattern searches in the message. If the message does not contain activity related information, the system proceeds to normal recommendation operation (operation 314). Next, the system converts the extracted information to a canonical form (operation 310). The system then stores the extracted information as an entry in canonical form in a repository (operation 312). Note that if the message contains activity related information, it is assumed that the message also contains at least some implicit temporal information.

The system further proceeds to normal recommendation operation. During the recommendation operation, the system activates activity recommendation (operation 314). The system then constructs a list of recommended activities (operation 316).

Subsequently, the system determines whether there is an entry in the repository that matches any of the recommended activities (operation 318). If there is a match, the system modifies the list of recommended activities by promoting or demoting the activities which are matched by entries in the repository (operation 320). Note that, in one embodiment, the temporal information of an activity can be used to determine whether an activity is to be promoted or demoted. For example, if the entry in the repository indicates that the user is eating dinner or has just eaten at a restaurant, the system will demote eating related activities. The system then produces the list of recommended activities (operation 322). If there is not a match in the repository, the system then produces an unmodified list of recommended activities (operation 322).

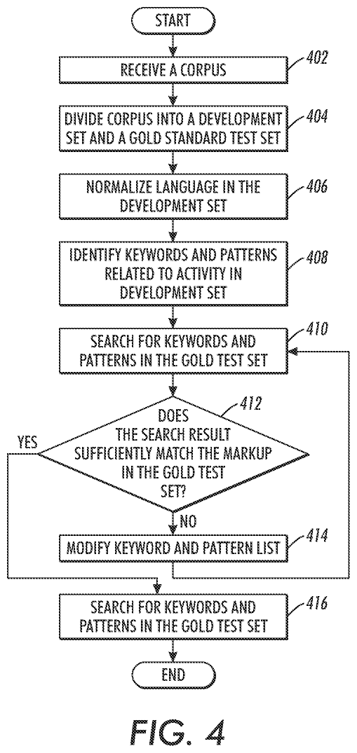

FIG. 4 presents a flow chart illustrating an exemplary process of obtaining a list of activity-related keywords and text patterns in accordance with one embodiment of the present invention. During operation, a corpus is obtained (operation 402). Next, the corpus is divided into a development set and a gold standard test set (operation 404). The language in the development set is then normalized by rules which remove meaningless text and correct typographical errors (operation 406). Keywords and text patterns related to activities are identified in the development set (operation 408). In one embodiment, the identification process is performed manually.

Next, the gold test set is searched for the keywords and patterns (operation 410). Whether the search result sufficiently matches the markup in the gold test set is then determined (operation 412). If there is a sufficient match, the keyword and pattern list are then stored for future use by the UCEE (operation 416). If there is not a sufficient match, the keyword and pattern list is modified (operation 414), and the gold test set is searched again using the modified keyword and pattern list (operation 410).

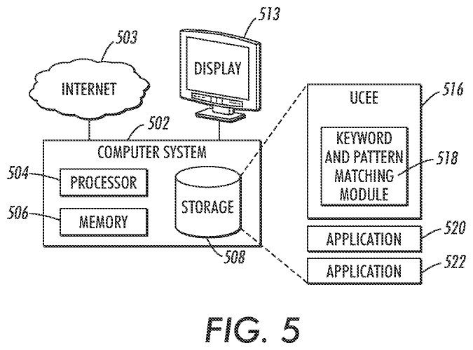

FIG. 5 illustrates a computer system for extracting implicit or explicit temporal and/or location information to facilitate activity recommendation in accordance with one embodiment of the present invention. A computer system 502 includes a processor 504, a memory 506, and a storage device 508. Computer system 502 is coupled to the Internet 503 and a display 513. In one embodiment, display 513 is a touch screen, which can also function as an input device. Storage device 508 stores a UCEE application 516, which in one embodiment performs the information extraction to content. UCEE application 516 includes a keyword and pattern matching module 518, which searches a message for keyword and pattern matches. Storage device 508 also stores applications 520 and 522. During operation, UCEE 516 which includes keyword and pattern matching module 518 is loaded into memory 506 and executed by processor 504. Correspondingly, processor 504 extracts implicit or explicit temporal and/or location information from content as described above.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

1.-25. (canceled)

26. A computer-executed method for recommending a shopping activity, the method comprising:
receiving, by a server of an activity management system, a message entered into a mobile device belonging to a user;
applying natural language processing (NLP) on the message to:
determine that the message is associated with an activity of the user; and
extract information associated with the activity in the message by performing operations comprising identifying, from a set of predetermined keywords, one or more keywords in which the user is interested;
storing, by the activity management system, the one or more keywords in an entry in a user profile database;
receiving, by the server of the activity management system, a query from the mobile device belonging to the user, wherein the query requests a recommendation for the user;
identifying, based on the query from the mobile device and the one or more one keywords stored in the user profile database, a recommendation for the shopping activity;
generating, based on the query from the mobile device, a list comprising a plurality of recommended activities, wherein the list includes the recommendation for the shopping activity; and
sending, from the server of the activity management system to the mobile device, the recommendation for the shopping activity for display to the user.

27. The method of claim 26, wherein identifying the one or more keywords comprises searching the message for one or more predetermined keywords or text patterns based on the application of the NLP on the message.

28. The method of claim 26 further comprising identifying an indication of willingness of the user to participate in the one or more keywords comprises:
determining, based on the application of the NLP on the message, that the shopping activity of the identified one or more keywords has occurred in the past, is occurring at the present time, or is going to occur at a future time; and
incorporating a relative positive or negative willingness of the user to participate in the identified one or more keywords into the indication of willingness.

29. The method of claim 28, further comprising:
determining, based on the application of the NLP on the message, a lack of willingness of the user to participate in the identified one or more keywords from the relative negative willingness in the indication of willingness; and
demoting the activity type for generating the recommendation.

30. The method of claim 28, further comprising:
determining, based on the application of the NLP on the message, a willingness of the user to participate in the identified one or more keywords from the relative positive willingness in the indication of willingness; and
promoting the activity type for generating the recommendation.

31. The method of claim 26, further comprising:
converting the identified one or more keywords, an indication of willingness, and location information to a canonical form that corresponds to the canonical form of the activity time; and
storing, in the entry, the converted information in association with the activity time in the canonical form.

32. The method of claim 26, further comprising causing the entry to expire in the use profile database based on the activity time in the entry and a set of pre-defined expiration rules.

33. The method of claim 26, further comprising:
receiving a second message from a second mobile device belonging to a second user; and
assigning a default future tense to the second message.

34. The method of claim 26, further comprising:
collecting statistics from a poll of users to determine a default time for an activity.

35. The method of claim 26, further comprising:
receiving a series of messages from the mobile device;
revising a model of plans for the user based on the series of messages based on the application of the NLP on the message;
reducing the probability of interest for the activity and increasing a second probability of interest for a second activity, based on the revised model; and
modifying the recommendation to incorporate the second activity in response to determining that the second probability of interest is above a predetermined threshold.

36. The method of claim 26, further comprising recording an uncertainty variable that indicates a degree to which the activity management system is uncertain of a value of an activity time.

37. A non-transitory computer-readable storage medium storing instructions which when executed by a computer cause the computer to perform a method for recommending activities, the method comprising:
receiving, by a server of an activity management system, a message entered into a mobile device belonging to a user;
applying natural language processing (NLP) on the message to:
determine that the message is associated with an activity of the user; and
extract information associated with the activity in the message by performing operations comprising identifying, from a set of predetermined keywords, one or more keywords in which the user is interested;
storing, by the activity management system, the one or more keywords in an entry in a user profile database;
receiving, by the server of the activity management system, a query from the mobile device belonging to the user, wherein the query requests a recommendation for the user;
identifying, based on the query from the mobile device and the one or more one keywords stored in the user profile database, a recommendation for the shopping activity;
generating, based on the query from the mobile device, a list comprising a plurality of recommended activities, wherein the list includes the recommendation for the shopping activity; and
sending, from the server of the activity management system to the mobile device, the recommendation for the shopping activity for display to the user.

38. The non-transitory computer-readable medium of claim 37, wherein identifying the one or more keywords comprises searching the message for one or more predetermined keywords or text patterns based on the application of the NLP on the message.

39. The non-transitory computer-readable medium of claim 37, wherein further comprising identifying an indication of willingness of the user to participate in the one or more keywords comprises:
determining, based on the application of the NLP on the message, that the shopping activity of the identified one or more keywords has occurred in the past, is occurring at the present time, or is going to occur at a future time; and
incorporating a relative positive or negative willingness of the user to participate in the identified one or more keywords into the indication of willingness.

40. The non-transitory computer-readable medium of claim 39, wherein the method further comprises:
determining, based on the application of the NLP on the message, a lack of willingness of the user to participate in the identified one or more keywords from the relative negative willingness in the indication of willingness; and
demoting the activity type for generating the recommendation.

41. The non-transitory computer-readable medium of claim 39, wherein the method further comprises:
determining, based on the application of the NLP on the message, a willingness of the user to participate in the identified one or more keywords from the relative positive willingness in the indication of willingness; and
promoting the activity type for generating the recommendation.

42. The non-transitory computer-readable medium of claim 37, wherein the method further comprises:
converting the identified activity type, an indication of willingness, and location information to a canonical form that corresponds to the canonical form of the activity time; and
storing, in the entry, the converted information in association with the activity time in the canonical form.

43. The non-transitory computer-readable medium of claim 37, wherein the method further comprises causing the entry to expire in the user profile database based on the activity time in the entry and a set of pre-defined expiration rules.

44. A computer system for recommending activities, the computer system comprising:
a processor;
a memory coupled to the processor;
a message receiver configured to receive a message entered into a mobile device belonging to a user;
a content extraction engine configured to applying natural language processing (NLP) on the message to:
determine that the message is associated with an activity of the user; and
extract information associated with the activity in the message by performing operations comprising identifying, from a set of predetermined keywords, one or more keywords in which the user is interested; wherein
the content extraction engine is further configured to store the one or more one keywords in an entry in a user profile database;
a recommender configured to:
receive a query from the mobile device belonging to the user, wherein the query requests a recommendation for the user;
generating, based on the query from the mobile device, a list comprising a plurality of recommended activities, wherein the list includes the recommendation for the shopping activity; and
identify, based on the query from the mobile device and the one or more one keywords stored in the user profile database, a recommendation for the shopping activity; and
a message sender configured to send the recommendation for the shopping activity for display to the user.

45. The computer system of claim 44, wherein while identifying the one or more keywords, the content extraction engine is configured to search the message for one or more predetermined keywords or text patterns based on the application of the NLP on the message.

46. The computer system of claim 44, wherein the content extraction engine is configured to identify an indication of willingness of the user to participate in the one or more keywords comprising:
determining, based on the application of the NLP on the message, that an activity of the identified one or more keywords has occurred in the past, is occurring at the present time, or is going to occur at a future time; and
incorporating a relative positive or negative willingness of the user to participate in the identified one or more keywords into the indication of willingness.

47. The computer system of claim 46, wherein the recommender is further configured to:
determine, based on the application of the NLP on the message, a lack of willingness to participate in the identified one or more keywords from the relative negative willingness in the indication of willingness; and
demote the one or more keywords for generating the recommendation.

48. The computer system of claim 46, wherein the recommender is further configured to:
determine, based on the application of the NLP on the message, a willingness to participate in the identified one or more keywords from the relative positive willingness in the indication of willingness; and
promote the one or more keywords for generating the recommendation.

49. The computer system of claim 44, wherein the content extraction engine is configured to:
convert the identified one or more keywords, an indication of willingness, and location information to a canonical form that corresponds to the canonical form of the activity time; and
store, in the entry, the converted information in association with the activity time in the canonical form.

50. The computer system of claim 44, wherein the user profile database is configured to cause the entry to expire in the user profile database based on the temporal information in the entry and a set of pre-defined expiration rules.

51. A computer-executed method for recommending a shopping activity, the method comprising:
receiving, by a server of an activity management system, a message entered into a mobile device belonging to a user;
applying natural language processing (NLP) on the message to:
determine that the message is associated with an activity of the user; and
extract information associated with the shopping activity in the message by performing operations comprising:
providing a corpus representing one or more writing styles of a user as a source for text patterns and keywords analysis;
determining whether the corpus needs an online secondary source for text patterns and keywords;
upon determining the corpus needs the online secondary source, incorporating information from the online secondary source to the corpus for augmenting the text patterns and keywords analysis;
searching, using the corpus, a set of predetermined keywords from the message related to the shopping activity;
identifying, from the set of predetermined keywords, one or more keywords in which the user is interested in the shopping activity; and
identifying, from the message and using the corpus, temporal, location, and preference information of the user for the shopping activity;
storing, by the activity management system, the one or more one keywords and temporal, location, and preference information in an entry in a user profile database;
receiving, by the server of the activity management system, a query from the mobile device belonging to the user, wherein the query requests a recommendation for the user;
identifying, based on the query from the mobile device and the one or more one keywords stored in the user profile database, a recommendation for the shopping activity;
generating, based on the query from the mobile device, a list comprising a plurality of recommended activities, wherein the list includes the recommendation for the shopping activity; and
sending, from the server of the activity management system to the mobile device, the recommendation for the shopping activity for display to the user.

52. The method of claim 51, further comprising identifying an indication of willingness of the user to participate in the identified one or more keywords comprising:
determining, based on the application of the NLP on the message, that the shopping activity of the identified one or more keywords has occurred in the past, is occurring at the present time, or is going to occur at a future time; and
incorporating a relative positive or negative willingness of the user to participate in the identified one or more keywords into the indication of willingness.

53. The method of claim 52, further comprising:
determining, based on the application of the NLP on the message, a lack of willingness of the user to participate in the identified one or more keywords from the relative negative willingness in the indication of willingness; and
demoting the one or more keywords for generating the recommendation.

54. The method of claim 52, further comprising:
determining, based on the application of the NLP on the message, a willingness of the user to participate in the identified one or more keywords from the relative positive willingness in the indication of willingness; and
promoting the one or more keywords for generating the recommendation.

55. The method of claim 51, further comprising:
converting the identified one or more keywords, an indication of willingness, and the temporal, location, and preference information to a canonical form that corresponds to the canonical form of an activity time; and
storing, in the entry, the converted information in association with the activity time in the canonical form.

56. The method of claim 26, further comprising causing the entry to expire in the user profile database based on an activity time in the entry and a set of pre-defined expiration rules.

57. The method of claim 51, further comprising:
receiving a second message from a second mobile device belonging to a second user; and
assigning a default future tense to the second message.

58. The method of claim 51, further comprising:
collecting statistics from a poll of users to determine a default time for an activity.

59. The method of claim 51, further comprising:
receiving a series of messages from the mobile device;
revising a model of plans for the user based on the series of messages based on the application of the NLP on the message;
reducing the probability of interest for the activity and increasing a second probability of interest for a second activity, based on the revised model; and
modifying the recommendation to incorporate the second activity in response to determining that the second probability of interest is above a predetermined threshold.

60. The method of claim 51, further comprising recording an uncertainty variable that indicates a degree to which the activity management system is uncertain of a value of an activity time.

61. A non-transitory computer-readable storage medium storing instructions which when executed by a computer cause the computer to perform a method for recommending activities, the method comprising:
receiving, by a server of an activity management system, a message entered into a mobile device belonging to a user;
applying natural language processing (NLP) on the message to:
determine that the message is associated with an activity of the user; and
extract information associated with the activity in the message by performing operations comprising:
providing a corpus representing one or more writing styles of a user as a source for text patterns and keywords analysis;
determining whether the corpus needs an online secondary source for text patterns and keywords;
upon determining the corpus needs the online secondary source, incorporating information from the online secondary source to the corpus for augmenting the text patterns and keywords analysis;
searching, using the corpus, a set of predetermined keywords from the message related to the shopping activity;
identifying, from the set of predetermined keywords, one or more keywords in which the user is interested in the shopping activity; and
identifying, from the message and using the corpus, temporal, location, and preference information of the user for the shopping activity;
storing, by the activity management system, the at least one keywords in an entry in a user profile database;
receiving, by the server of the activity management system, a query from the mobile device belonging to the user, wherein the query requests a recommendation for the user;
identifying, based on the query from the mobile device and the one or more one keywords stored in the user profile database, a recommendation for the shopping activity;
generating, based on the query from the mobile device, a list comprising a plurality of recommended activities, wherein the list includes the recommendation for the shopping activity; and
sending, from the server of the activity management system to the mobile device, the recommendation for the shopping activity for display to a user.

62. The non-transitory computer-readable storage medium of claim 61, further comprising identifying an indication of willingness of the user to participate in the identified one or more keywords comprising:
determining, based on the application of the NLP on the message, that the shopping activity of the identified one or more keywords has occurred in the past, is occurring at the present time, or is going to occur at a future time; and
incorporating a relative positive or negative willingness of the user to participate in the identified one or more keywords into the indication of willingness.

63. The non-transitory computer-readable storage medium of claim 62, further comprising:
determining, based on the application of the NLP on the message, a lack of willingness of the user to participate in the identified one or more keywords from the relative negative willingness in the indication of willingness; and
demoting the one or more keywords for generating the recommendation.

64. The non-transitory computer-readable storage medium of claim 62, further comprising:
determining, based on the application of the NLP on the message, a willingness of the user to participate in the identified one or more keywords from the relative positive willingness in the indication of willingness; and
promoting the one or more keywords for generating the recommendation.

65. The non-transitory computer-readable storage medium of claim 61, further comprising:
converting the identified one or more keywords, an indication of willingness, and the temporal, location, and preference information to a canonical form that corresponds to the canonical form of an activity time; and
storing, in the entry, the converted information in association with the activity time in the canonical form.

66. The non-transitory computer-readable storage medium of claim 61, further comprising causing the entry to expire in the user profile database based on an activity time in the entry and a set of pre-defined expiration rules.

67. The non-transitory computer-readable storage medium of claim 61, further comprising:
receiving a second message from a second mobile device belonging to a second user; and
assigning a default future tense to the second message.

68. The non-transitory computer-readable storage medium of claim 61, further comprising:
collecting statistics from a poll of users to determine a default time for an activity.

69. The non-transitory computer-readable storage medium of claim 61, further comprising:
receiving a series of messages from the mobile device;
revising a model of plans for the user based on the series of messages based on the application of the NLP on the message;
reducing the probability of interest for the activity and increasing a second probability of interest for a second activity, based on the revised model; and
modifying the recommendation to incorporate the second activity in response to determining that the second probability of interest is above a predetermined threshold.

70. The non-transitory computer-readable storage medium of claim 61, further comprising recording an uncertainty variable that indicates a degree to which the activity management system is uncertain of a value of an activity time.

71. A computer system for recommending activities, the computer system comprising:
a processor;
a memory coupled to the processor;
a message receiver configured to receive a message entered into a mobile device belonging to a user;
a content extraction engine configured to applying natural language processing (NLP) on the message to:
determine that the message is associated with an activity of the user; and
extract information associated with the activity in the message by performing operations comprising:
providing a corpus representing one or more writing styles of a user as a source for text patterns and keywords analysis;
determining whether the corpus needs an online secondary source for text patterns and keywords analysis;
upon determining the corpus needs the online secondary source, incorporating information from the online secondary source to the corpus for augmenting the text patterns and keywords analysis;
searching, using the corpus, a set of predetermined keywords from the message related to the shopping activity;
identifying, from the set of predetermined keywords, one or more keywords in which the user is interested in the shopping activity; and
identifying, from the message and using the corpus, temporal, location, and preference information of the user for the shopping activity; wherein
the content extraction engine is further configured to store the one or more keywords in an entry in the user profile database;
a recommender configured to:
receive a query from the mobile device belonging to the user, wherein the query requests a recommendation for the user;
generating, based on the query from the mobile device, a list comprising a plurality of recommended activities, wherein the list includes the recommendation for the shopping activity; and
identify, based on the query from the mobile device and the one or more keywords stored in the user profile database, a recommendation for the shopping activity; and
a message sender configured to send, from the server of the activity management system to the mobile device, the recommendation for the shopping activity for display to the user.

72. The computer system of claim 71, wherein the content extraction engine is configured to:
identify an indication of willingness of the user to participate in the identified one or more keywords by performing operations comprising:
determining, based on the application of the NLP on the message, that the shopping activity of the identified one or more keywords has occurred in the past, is occurring at the present time, or is going to occur at a future time; and
incorporating a relative positive or negative willingness of the user to participate in the identified one or more keywords into the indication of willingness.

73. The computer system of claim 72, wherein the content extraction engine is configured to:
determine, based on the application of the NLP on the message, a lack of willingness of the user to participate in the identified one or more keywords from the relative negative willingness in the indication of willingness; and
demote the one or more keywords for generating the recommendation.

74. The computer system of claim 72, wherein the content extraction engine is configured to:
determine, based on the application of the NLP on the message, a willingness of the user to participate in the identified one or more keywords from the relative positive willingness in the indication of willingness; and
promote the one or more keywords for generating the recommendation.

75. The computer system of claim 71, wherein the recommender is configured to:
convert the identified one or more keywords, an indication of willingness, and the temporal, location, and preference information to a canonical form that corresponds to the canonical form of an activity time; and
store, in the entry, the converted information in association with the activity time in the canonical form.

76. The computer system of claim 71, wherein the user profile database is configured to cause the entry to expire based on an activity time in the entry and a set of pre-defined expiration rules.

77. The computer system of claim 71, wherein the content extraction engine is configured to:
receive a second message from a second mobile device belonging to a second user; and
assigning a default future tense to the second message.

78. The computer system of claim 71, wherein the content extraction engine is configured to:
collect statistics from a poll of users to determine a default time for an activity.

79. The computer system of claim 71, wherein the content extraction engine is configured to:
receive a series of messages from the mobile device;
revise a model of plans for the user based on the series of messages based on the application of the NLP on the message;
reduce the probability of interest for the activity and increasing a second probability of interest for a second activity, based on the revised model; and
modify the recommendation to incorporate the second activity in response to determining that the second probability of interest is above a predetermined threshold.

80. The method of claim 71, wherein the content extraction engine is configured to record an uncertainty variable that indicates a degree to which the activity management system is uncertain of a value of an activity time.
